(19) United States
(12) Patent Application Publication
(10) Pub. No.: US 2018/0060312 A1
(43) Pub. Date: Mar. 1, 2018

(54) PROVIDING IDEOGRAM TRANSLATION

(71) Applicant: MICROSOFT TECHNOLOGY LICENSING, LLC, Redmond, WA (US)

(72) Inventor: Sung Joon Won, Seattle, WA (US)

(73) Assignee: MICROSOFT TECHNOLOGY LICENSING, LLC, Redmond, WA (US)

(21) Appl. No.: 15/243,987

(22) Filed: Aug. 23, 2016

(51) Int. Cl. G06F 17/28; G06F 17/30; G06F 17/27

(52) U.S. Cl. CPC G06F 17/2881; G06F 17/2836; G06F 17/2775; G06F 17/30684

(57) ABSTRACT

Various approaches to provide ideogram translation are described. A communication application initiates operations to translate ideogram(s) upon detecting a message created by a sender that includes ideogram(s). A translation of the ideogram(s) is generated based on a content of the ideogram(s) and contextual information associated with the message. The contextual information includes a sender context, a recipient context, or a message context. The translation is provided to the recipient for display.

### BACKGROUND

Information collection, management, and analysis have changed work processes and associated data management. Automation and improvements in daily processes have expanded scope of capabilities offered by applications consumed daily by users. With the development of faster and smaller electronics, execution of mass processes at systems providing applications and services have become feasible. Indeed, services enhancing provided applications have become common features in modern application environments. Such systems provide a wide variety of applications such as web browsers that present users with expanded functionality. Many such applications provide communication modalities and attempt to improve media consumption. Communication applications consume significant resources but have large potential for performance improvements through automation.

Ideograms are a popular communication modality. However, many users do not know how to interpret ideograms or how to type in ideograms. Furthermore, some users are not sufficiently savvy to communicate with ideograms with sufficient speed. Amount of available ideograms further complicate communication with ideograms. Ideogram variation and numbers are extensive. A common user spends significant time to find ideograms in demand. Lack of easy to use ideogram communication modalities lead to underutilization of ideograms as a communication medium.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to ideogram translation. A communication application, according to embodiments, may detect a message being created, where the message includes one or more ideograms, and generate a translation of the one or more ideograms into text based on a content of the one or more ideograms and a contextual information associated with the message, the contextual information including one or more of a sender context, a recipient context, and a message context. The communication application may also identify two or more translations of the one or more ideograms, present the two or more translations to a sender for a selection among the two or more translations, and receive the selection among the two or more translations. The communication application may then provide the selection among the two or more translations to a communication module to be transmitted to a recipient for display.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing ideogram translation, according to embodiments;

FIG. 2 is a display diagram illustrating example components of a communication application that translates ideogram(s), according to embodiments;

FIG. 3 is a display diagram illustrating components of a scheme to translate ideogram(s) in a communication application, according to embodiments;

FIG. 4 is a display diagram illustrating a scheme to translate ideogram(s) using Unicode character intermediaries, according to embodiments;

FIG. 5 is a simplified networked environment, where a system according to embodiments may be implemented;

FIG. 6 is a block diagram of an example computing device, which may be used to provide ideogram translation, according to embodiments; and

FIG. 7 is a logic flow diagram illustrating a process for providing ideogram translation, according to embodiments.

### DETAILED DESCRIPTION

As briefly described above, ideogram(s) in an exchanged message may be translated into text. An ideogram or ideograph is a graphic symbol that represents an idea or concept, independent of any particular language, and specific words or phrases. Some ideograms may be comprehensible by familiarity with prior convention; others may convey their meaning through pictorial resemblance to a physical object, and thus may also be referred to as pictograms. In an example scenario, the communication application may detect a message with ideogram(s), for example a smiling face ( [symbol] ), a frowning face ( [symbol] ), and/or a heart (♡), among others. The communication application may process ideogram(s) (detected in the message) to generate a translation based on a content of the ideogram(s) and a contextual information associated with the message. The contextual information may include a sender context, a recipient context, and/or a message context. Each ideogram in the message may be matched to a corresponding word. However, in scenarios where the ideogram may correspond to multiple words, the user may be provided with a selection prompt to select the correct word that may be used to translate the ideogram. Next, the translation may be presented to the recipient for display.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide ideogram translation. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

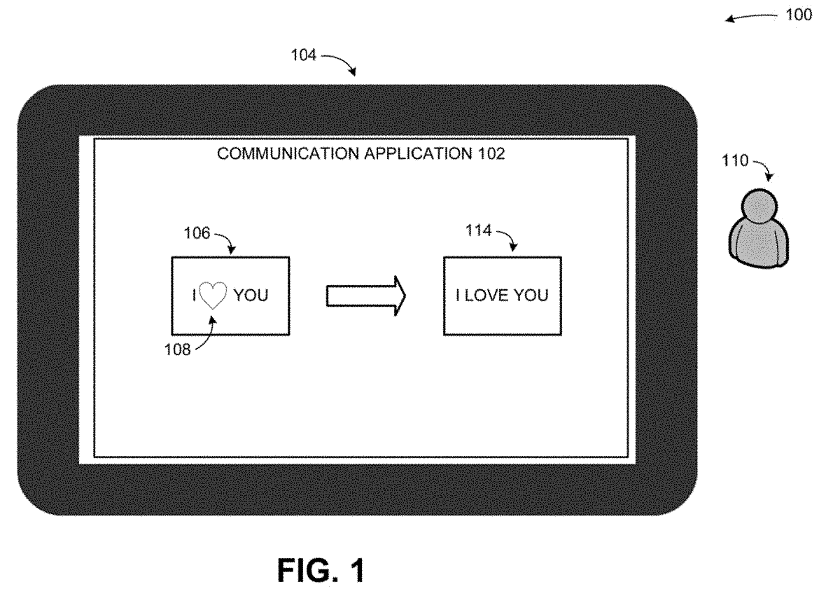

FIG. 1 is a conceptual diagram illustrating examples of providing ideogram translation, according to embodiments.

In a diagram 100, a computing device 104 may execute a communication application 102. The communication application 102 may include a messaging application. The computing device 104 may include a physical computer and/or a mobile computing device such as a smart phone and/or similar ones. The computing device 104 may also include a special purpose and/or configured components that is optimized to transmit ideograms through the communication application 102. For example, a communication component of the computing device 104 may be customized to translate an ideogram to Unicode characters and transmit and receive the ideogram(s) as Unicode characters.

The computing device 104 may execute the communication application 102. The communication application 102 may initiate operations to translate ideogram(s) upon detecting a message 106 being created by a sender 110 that includes ideogram(s). An ideogram 108 may include a graphic that reflects an emotional state. Example of the ideogram may include a smiling face ( [symbol] ), a frowning face ( [symbol] ), and/or a heart (♡), among others. The ideogram 108 may be displayed as a graphic, an image, an animation, and/or similar ones. The message 106 may include components such as the ideogram 108 and word(s) that surround the ideogram 108. Alternatively, the message 106 may only include the ideogram 108 and other ideogram(s).

A user of the communication application 102 such as the sender 110 may desire to communicate with ideogram(s) but lack the knowledge or the know how to do so. As such, the communication application 102 may provide automated ideogram translation. The communication application 102 may process the ideogram 108 to generate a translation 114 based on a content of the ideogram 108 and a contextual information associated with the message 106. The contextual information may include a sender context, a recipient context, and/or a message context, among others. For example, relationship(s) between the ideogram 108 and components of the message 106 (such as words that surround the ideogram 108) may be analyzed to identify a structure of the message 106 in relation to the ideogram 108. A sentence and/or a set of words that have a structure similar to the message 106 may be selected as the translation 114.

The computing device 104 may communicate with other client device(s) or server(s) through a network. The network may provide wired or wireless communications between network nodes such as the computing device 104, other client device(s) and/or server(s), among others. Previous example(s) to providing ideogram translation in the communication application 102 are not provided in a limiting sense. Alternatively, the communication application 102 may transmit the message 106 to an ideogram translation provider and receive the translation 114 from the ideogram translation provider, among others.

The sender 110 may interact with the communication application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 104, the communication application 102, embodiments are not limited to these components or system configurations and can be implemented with other system configuration employing fewer or additional components.

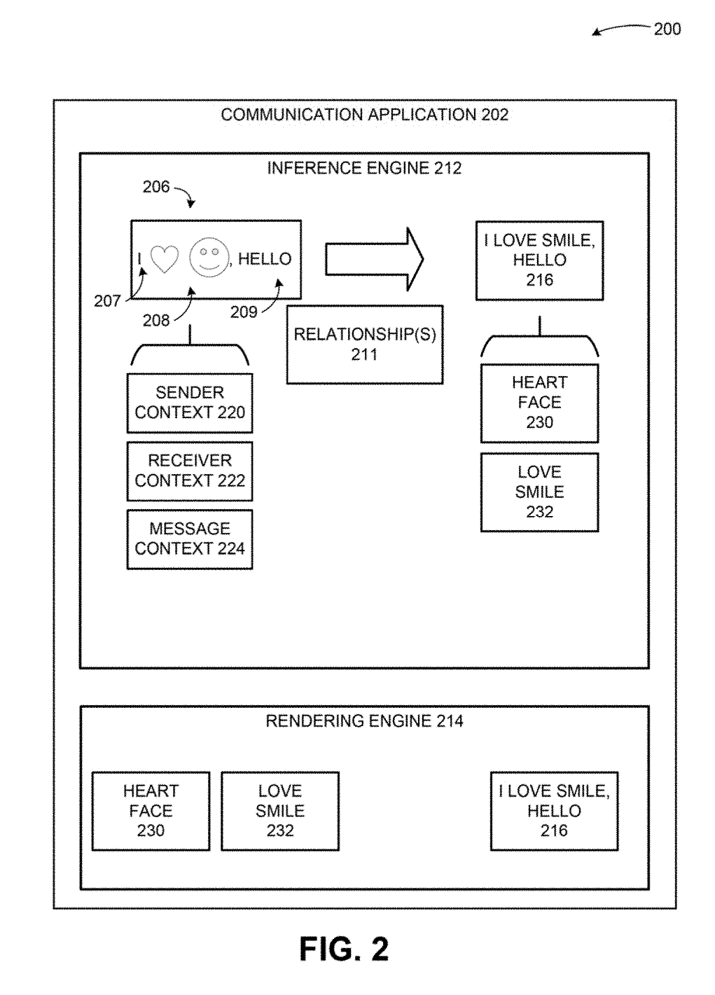

FIG. 2 is a display diagram illustrating example components of a communication application that translates ideogram(s), according to embodiments.

In a diagram 200, an inference engine 212 of a communication application 202 may detect a message 206 created by a sender that includes ideograms 208. The ideograms 208 may include a heart ( [symbol] ) and a smiling face (♡). The inference engine 212 may generate a translation 216 of the ideograms 208 to text based on a content of the ideograms 208 and contextual information associated with the message 206. The contextual information may include a sender context 220, a recipient context 222, and a message context 224.

The inference engine 212 may process the ideograms 208 to identify translations of the ideograms 208. For example, the inference engine 212 may query an ideogram translation dictionary of the communication application 202 with the ideograms 208. The inference engine 212 may locate a translation 230 (love and heart) and another translation 232 (smile and face). Upon locating two or more translations, the inference engine 212 may interact with a sender of the message 206 to prompt the sender to select one that may be used as the translation 216.

In an example scenario, a rendering engine 214 may be instructed to provide a listing of the translation 230 and the translation 232 to prompt the sender to make a selection. Upon receiving the selection, the inference engine 212 may designate the selection as the translation 216. The translation 216 may be saved into the ideogram translation dictionary in relation to the ideograms 208. Furthermore, the rendering engine 214 may be instructed to present the translation 216 to the recipient for display.

The inference engine 212 may also process the ideograms 208 based on a message context 224. For example, a structure of the message 206 may be detected within the message context 224. The structure may include location of components of the message 206, relationships that define the location of the components, and/or grammatical relationships between the components, among others. The inference engine 212 may process the word 207 and the ideograms 208 within the message 206 to identify relationships 211 between the word and the ideograms 208. The translation 216 may be generated based on the relationships 211.

For example, the inference engine 212 may detect a noun such as “I” as the word 207. The inference engine 212 may infer that a verb may follow the word 207 based on a grammatical relationship and a location relationship between the word 207 and the ideograms 208. As such, the inference engine 212 may query an ideogram translation provider with the structure of the message 206, the word 207, and the relationships detected between the word 207 and the ideograms 208 (in addition to a content of the ideograms 208). In response, the inference engine 212 may receive the translation 216 from the ideogram translation provider. The translation may match the structure of the message and include the word 207 and the relationships 211.

Alternatively, the inference engine 212 may query a sentence fragment provider with the word 207 and the relationships 211. In response, a sentence fragment (such as I love smile) may be received from the sentence fragment provider. The translation 216 may be generated by replacing the word 207 and the ideograms 208 with the sentence fragment. As such, only a set of components of the message surrounding the ideograms 208 may be processed to detect relationships which may lower resource consumption compared to processing remaining components 209 of the message 206.

The inference engine 212 may also analyze contextual information associated with the sender to translate the ideograms 208. The inference engine 212 may identify attributes of the sender. The attributes may include a role, a presence information, an emotional state, and/or a location of the sender, among others. The translations (230 and 232) may be filtered based on the attributes. For example, a translation that does not match the emotional state of the sender may not be included in a list of possible translations. The filtered translations may be provided to the sender for a selection. Upon receiving the selection from the sender, the translation 216 may be generated from the selection.

For example, the inference engine 212 may detect an emotional state of the sender as happy (for example, by recognizing the emotional state from a third party information provider such as a social networking provider, a camera associated with the user's device, and/or the context of the message the user has typed). The inference engine 212 may filter out a number of the translations that do not match the emotional state of the sender. The translations (230 and 232) may correlate with the happy emotional state of the sender. As such, the translations (230 and 232) may be presented to the sender for a selection through the rendering engine 214. The selected translation may be used to generate the translation 216.

Similarly, contextual information associated with the recipient may be analyzed to translate the ideograms 208. The inference engine 212 may identify attributes of the recipient. The attributes may include a role, a presence information, an emotional state, and/or a location of the recipient, among others. The translations (230 and 232) may be filtered based on the attributes. The filtered translations may be provided to the sender or the recipient for a selection. Upon receiving the selection from the sender or the recipient, the translation 216 may be generated from the selection.

For example, the inference engine 212 may detect an emotional state of the recipient as happy (for example, by recognizing the emotional state from a third party information provider such as a social networking provider, a camera associated with the user's device, and/or the context of the message the user has typed). The inference engine 212 may filter out a number of the translations that do not match the emotional state of the recipient. The translations (230 and 232) may correlate with the happy emotional state of the recipient. The translations (230 and 232) may be presented to the recipient or the sender for a selection through the rendering engine 214. The selected translation may be used to generate the translation 216.

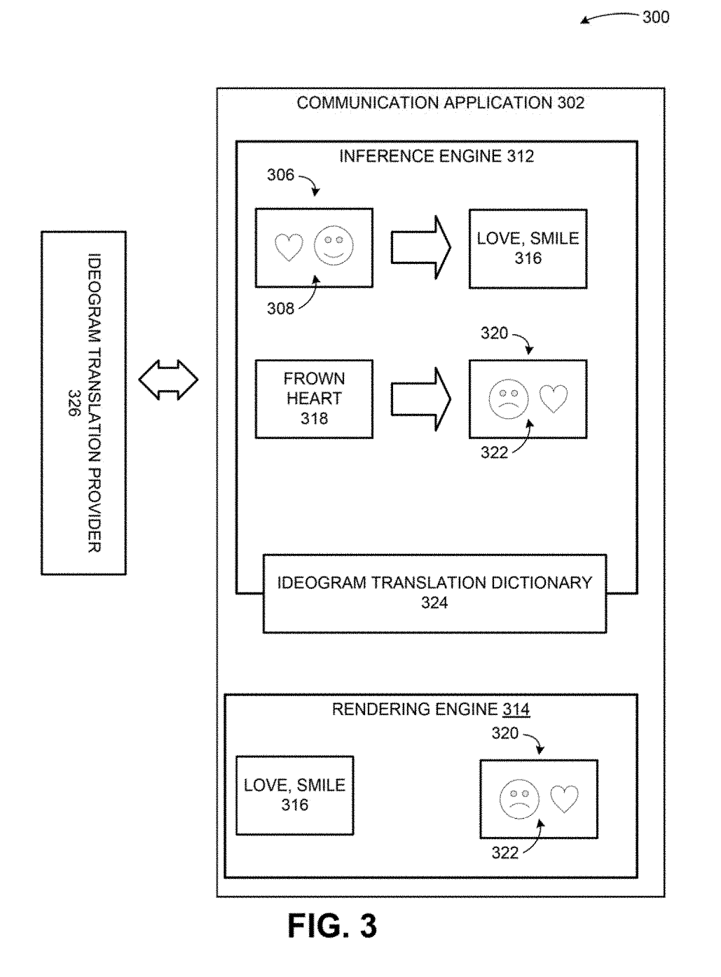

FIG. 3 is a display diagram illustrating components of a scheme to translate ideogram(s) in a communication application, according to embodiments.

In a diagram 300, an inference engine 312 of the communication application 302 may process ideograms 308 within a message 306 to generate a translation 316. Alternatively, the communication engine may translate words of a new message 318 to new ideograms 322.

For example, the inference engine 312 may detect a message 306 that includes ideograms 308. The inference engine 312 may query an ideogram translation dictionary 324 to locate translations that match the ideograms 308. If two or more translations are detected, the rendering engine 314 is prompted to provide the translations to a sender of the message 306 to request the sender to make a selection. Upon receiving the selection, the selection may be used to generate the translation 316. Alternatively, if the ideograms 308 match a single set of translations, the translations may be used to generate the translation 316.

Furthermore, the ideograms 308 may be translated through an ideogram translation provider 326. The ideogram translation provider may be provided with the message 306 to process the ideograms 308, generate the translation 316, and transmit the translation 316 to the communication application 302. Upon receiving the translation 316 (from the ideogram translation provider 326), the rendering engine 314 may be prompted to provide the translation 316 to be transmitted to a recipient for display.

In another scenario, a new message 318 may be detected. The new message 318 may have a content that solely includes words. The ideogram translation dictionary may be queried for a new translation 320 that includes new ideograms 322. The new translation 320 may be found in the ideogram translation dictionary 324. Next, the new translation 320 may be presented to the recipient through the rendering engine 314. Alternatively, if two or more ideogram translations of the words (of the new message 318) are detected, the ideogram translations may be presented to the sender for a selection. A selected ideogram translation may be used to generate the new translation 320.

Furthermore, the ideogram translation provider 326 may be used to translate the new message 318. For example, the inference engine 312 may directly query the ideogram translation provider 326 to translate the message 318 to the new translation 320 (with the new ideograms 322). Alternatively, the ideogram translation provider 326 may be queried (with the new message 318) upon a failure to locate the new translation 320 within the ideogram translation dictionary 324.

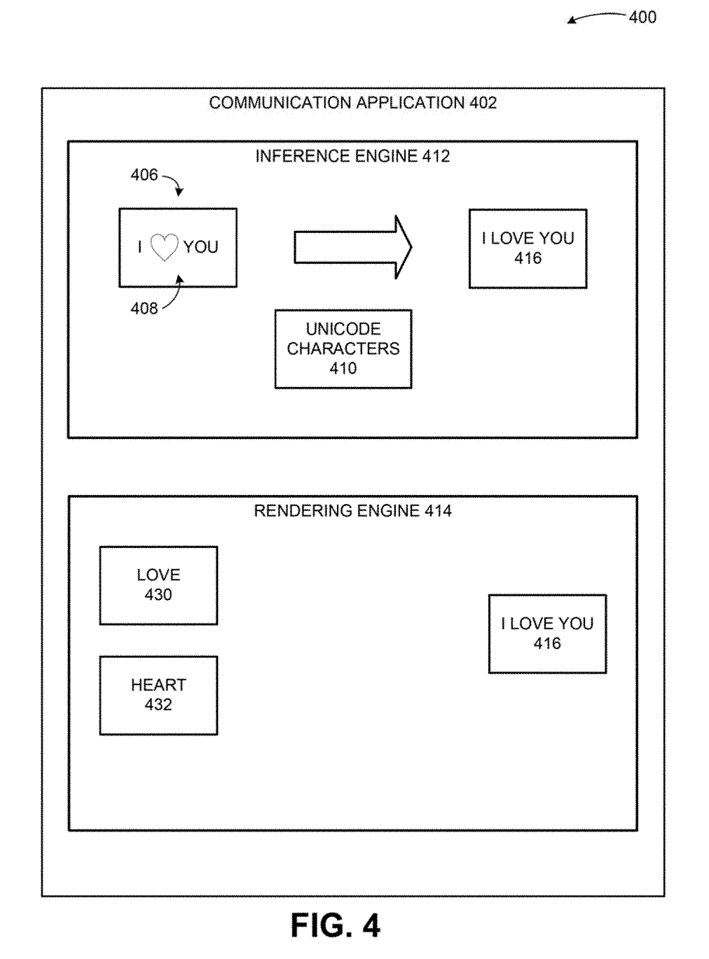

FIG. 4 is a display diagram illustrating a scheme to translate ideogram(s) using Unicode character intermediaries, according to embodiments.

In a diagram 400, an inference engine 412 of a communication application 402 may translate a message 406 with an ideogram 408 by converting the ideogram 408 to Unicode characters 410. An ideogram translation dictionary may be queried with the Unicode characters 410 to locate a translation associated with the Unicode characters 410. The translation may be used to construct a translated sentence 416 by replacing the ideogram 408 with the translation. The translated sentence 416 may be presented to the recipient as the translation of the message 406 through the rendering engine 414.

However, if the search results in two or more translations (430 and 432) of the ideogram 408 then the inference engine 412 may prompt the rendering engine 414 to provide the two or more translations (430 and 432) for a selection to the sender. The sender may be instructed to make a selection from the two or more translations (430 and 432). Upon detecting the selection, the selected translation (430) may be used to construct the translated sentence 416.

As discussed above, the communication application may be employed to provide ideogram translation. An increased user efficiency with the communication application 102 may occur as a result of processing the ideogram and components of a message that have a relationship with the ideogram to generate the translation. Additionally, automatically translating ideograms to words or words to ideograms within a communication based on user demand, by the communication application 102, may reduce processor load, increase processing speed, conserve memory, and reduce network bandwidth usage.

Embodiments, as described herein, address a need that arises from a lack of efficiency to provide ideogram translation. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing ideogram translation may be implemented in configurations employing fewer or additional components in applications and user interfaces. Furthermore, the example schema and components shown in FIG. 1 through 4 and their subcomponents may be implemented in a similar manner with other values using the principles described herein.

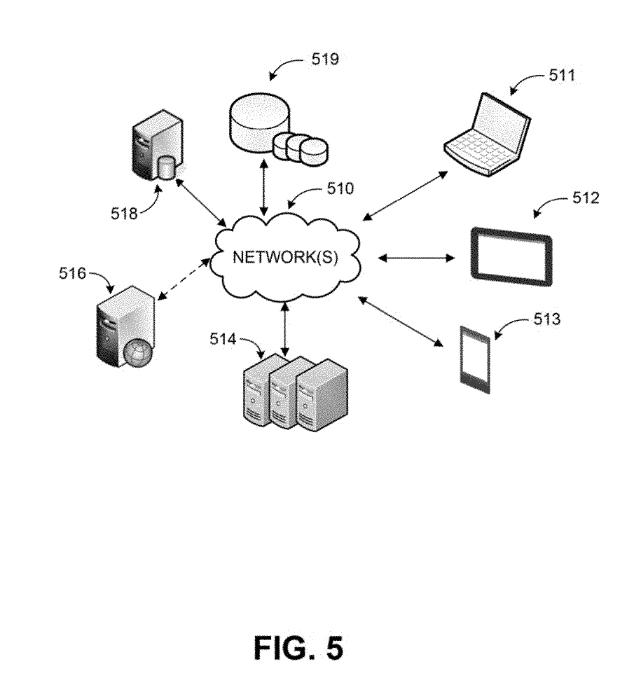

FIG. 5 is an example networked environment, where embodiments may be implemented. A communication application configured to translate ideograms may be implemented via software executed over one or more servers 514 such as a hosted service. The platform may communicate with communication applications on individual computing devices such as a smart phone 513, a mobile computer 512, or desktop computer 511 (‘client devices’) through network(s) 510.

Communication applications executed on any of the client devices 511-513 may facilitate communications via application(s) executed by servers 514, or on individual server 516. A communication application may detect a message created by a sender that includes ideogram(s). The ideogram(s) may be processed to generate a translation based on a content of the ideogram and contextual information associated with the message. The contextual information may include a sender context, a recipient context, and/or a message context. Next, the translation may be provided for display to the recipient. The communication application may store data associated with the ideograms in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide ideogram translation. Furthermore, the networked environments discussed in FIG. 5 are for illustration purposes only. Embodiments are not limited to the example applications, modules, or processes.

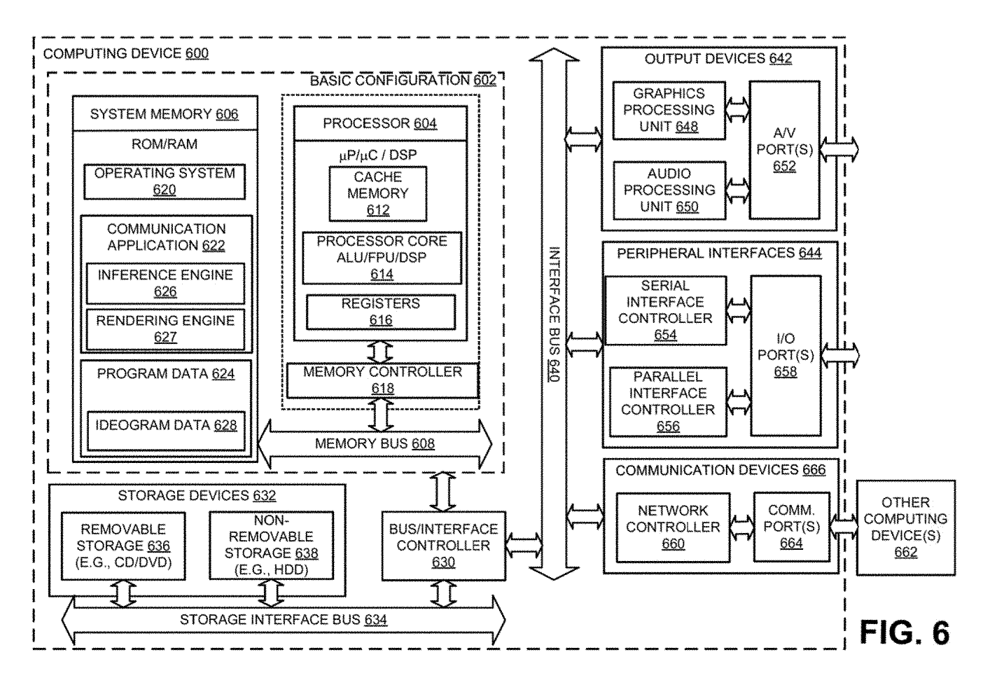

FIG. 6 is a block diagram of an example computing device, which may be used to provide ideogram translation, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication application 622, and a program data 624. The communication application 622 may include components such as an inference engine 626 and a rendering engine 627. The inference engine 626 and the rendering engine 627 may execute the processes associated with the communication application 622. The inference engine 626 may detect a message created by a sender that includes ideogram(s). The ideogram(s) may be processed to generate a translation based on a content of the ideogram and contextual information associated with the message. The contextual information may include a sender context, a recipient context, and/or a message context. Next, the rendering engine 627 may provide the translation to the recipient for display.

The communication application 622 may provide a message through a communication module associated with the computing device 600. An example of the communication module may include a communication device 666, among others that may be communicatively coupled to the computing device 600. The program data 624 may also include, among other data, ideogram data 628, or the like, as described herein. The ideogram data 628 may include translations.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide ideogram translation. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

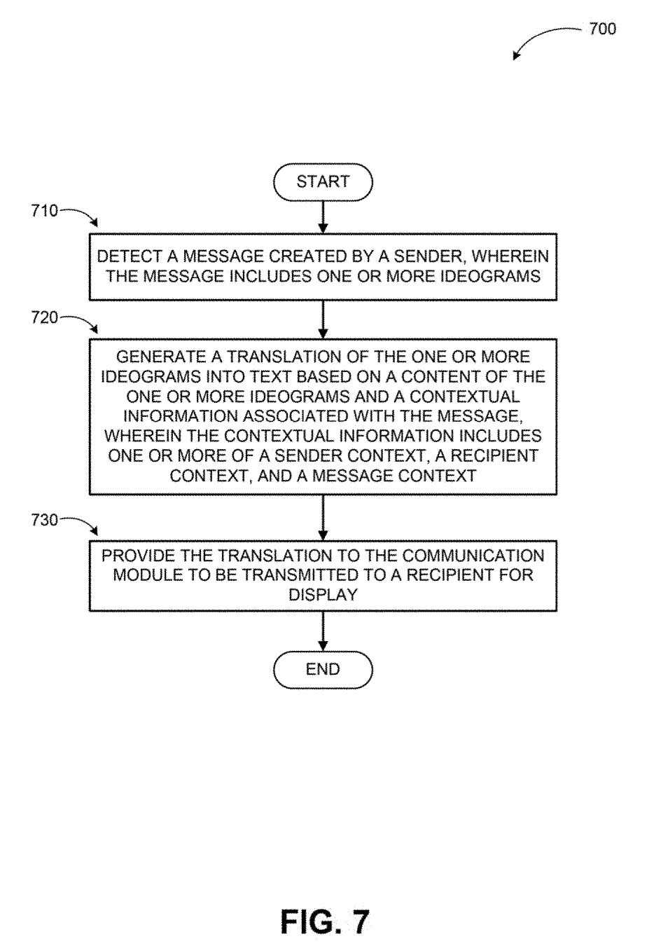

FIG. 7 is a logic flow diagram illustrating a process for providing ideogram translation, according to embodiments. Process 700 may be implemented on a computing device, such as the computing device 600 or another system.

Process 700 begins with operation 710, where the communication application detects a message created by a sender that includes ideogram(s). An ideogram may include a graphic that reflects an emotional state. The communication application may generate a translation of the ideogram(s) based on a content of the ideogram(s) and a contextual information associated with the message at operation 720. The contextual information may include a sender context, a recipient context, and/or a message context. Each ideogram in the message may be matched to a translation. However, in scenarios where the ideogram may correspond to multiple translations, the sender may be provided with a selection prompt to select the correct translation that may be used to translate the ideogram. Next, at operation 730, the translation may be provided to a recipient for display.

The operations included in process 700 is for illustration purposes. Providing ideogram translation may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device to provide ideogram translation is described. The computing device includes a communication module, a memory configured to store instructions associated with a communication application, a processor coupled to the memory and the communication module. The processor executes the communication application in conjunction with the instructions stored in the memory. The communication application includes an inference engine and a rendering engine. The inference engine is configured to detect a message created by a sender, where the message includes one or more ideograms and generate a translation of the one or more ideograms into text based on a content of the one or more ideograms and a contextual information associated with the message, where the contextual information includes one or more of a sender context, a recipient context, and a message context. The rendering engine is configured to provide the translation to the communication module to be transmitted to a recipient for display.

In other examples, the inference engine is further configured to identify two or more translations of the one or more ideograms and prompt the rendering engine to present the two or more translations to the sender for a selection among the two or more translations. The inference engine is further configured to receive the selection among the two or more translations from the sender, designate the selection among the two or more translations as the translation corresponding to the one or more ideograms, and save the one or more ideograms and the translation in an ideogram translation dictionary.

In further examples, the inference engine is further configured to detect a structure of the message as the message context, where the structure includes one or more words adjacent to the one or more ideograms, process the one or more words and the one or more ideograms to identify one or more relationships between the one or more words and the one or more ideograms, and generate the translation of the one or more ideograms based on the one or more relationships with the one or more words. The inference engine is further configured to query an ideogram translation provider with the structure of the message, the one or more words, and the one or more relationships and receive the translation from the ideogram translation provider. The inference engine is further configured to query a sentence fragment provider with the structure of the message, the one or more words and the one or more relationships, receive a sentence fragment that matches the one or more relationships from the sentence fragment provider, where the sentence fragment includes the one or more words, and generate the translation by replacing the one or more words and the one or more ideograms with the sentence fragment within the message.

In other examples, the inference engine is further configured to analyze the sender context to identify an attribute of the sender, where the attribute of the sender includes one or more of a role, a presence information, an emotional state, and a location of the sender and generate the translation of the one or more ideograms based on a selection of one or more textual equivalents for the one or more ideograms based on the identified attribute. The inference engine is further configured to analyze the recipient context to identify an attribute of the recipient, where the attribute of the recipient includes one or more of a role, a presence information, an emotional state, and a location of the recipient and generate the translation of the one or more ideograms based on a selection of one or more textual equivalents for the one or more ideograms based on the identified attribute.

In further examples, the inference engine is further configured to identify two or more textual equivalents for the one or more ideograms, analyze the two or more textual equivalents based on the one or more of the sender context, the recipient context, and the message context, and select one of the two or more textual equivalents as the translation based on the analysis. The inference engine is further configured to provide the one or more ideograms along with the translation to the communication module to be transmitted to a recipient for display. The one or more ideograms include one of an icon, a pictogram, and an emoji.

In some examples, a method executed on a computing device to provide ideogram translation is described. The method includes detecting a message being created, where the message includes one or more ideograms, generating a translation of the one or more ideograms into text based on a content of the one or more ideograms and a contextual information associated with the message, where the contextual information includes one or more of a sender context, a recipient context, and a message context, identifying two or more translations of the one or more ideograms, presenting the two or more translations to a sender for a selection among the two or more translations, receiving the selection among the two or more translations, and providing the selection among the two or more translations to a communication module to be transmitted to a recipient for display.

In other examples, the method further includes converting the one or more ideograms to one or more sets of Unicode characters that correspond to the one or more ideograms, searching an ideogram translation dictionary using the one or more sets of Unicode characters, locating one or more words that match the one or more sets of Unicode characters, and generating translation from the one or more words. Generating the translation of the one or more ideograms based on the sender context includes analyzing a history of the sender's messages to other recipients and identifying the two or more translations based on the analysis. Generating the translation of the one or more ideograms based on the recipient context includes analyzing a history of the recipient's messages from other senders and identifying the two or more translations based on the analysis. Generating the translation of the one or more ideograms based on the message context includes analyzing one or more of a conversation that includes the message, a prior message, and a number of recipients and identifying the two or more translations based on the analysis.

In some examples, a computer-readable memory device with instructions stored thereon to provide ideogram translation is described. The instructions include receiving a message that includes one or more ideograms, generating a translation of the one or more ideograms into text based on a content of the one or more ideograms and a contextual information associated with the message, where the contextual information includes one or more of a sender context, a recipient context, and a message context, and providing the translation to a recipient of the message for display.

In other examples, the instructions further include detecting a structure of the message within the message context, where the structure includes one or more words adjacent to the one or more ideograms, processing the one or more words and the one or more ideograms to identify one or more relationships between the one or more words and the one or more ideograms, and generating the translation of the one or more ideograms based on the one or more relationships with the one or more words. The instructions further include analyzing one or more of a history of the recipient's messages from other senders, a history of the sender's messages to other recipients, a conversation that includes the message, a prior message, and a number of recipients and generating the translation based on the analysis.

In some examples a means for providing ideogram translation is described. The means for providing ideogram translation includes a means for detecting a message created by a sender, where the message includes one or more ideograms, a means for generating a translation of the one or more ideograms into text based on a content of the one or more ideograms and a contextual information associated with the message, where the contextual information includes one or more of a sender context, a recipient context, and a message context, and a means for providing the translation to a recipient for display.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A computing device to provide ideogram translation, the computing device comprising:
a communication module;
a memory configured to store instructions associated with a communication application;
a processor coupled to the memory and the communication module, the processor executing the communication application in conjunction with the instructions stored in the memory, wherein the communication application includes:
an inference engine configured to:
detect a message created by a sender, wherein the message includes an ideogram;
determine contextual information associated with the message by analyzing a sender context, a recipient context and a message context based on one or more of: a presence information, an emotional state, or a location of the sender or a recipient;
automatically generate a translation of the ideogram into text by:
generating a list of possible translations based on a content of the ideogram; and
filtering the list of possible translations based on contextual information associated with the message; and
a rendering engine configured to:
provide the translation to the communication module to be transmitted to the recipient for display.

2. The computing device of claim 1, wherein the inference engine is further configured to:
identify two or more translations of the ideogram; and
prompt the rendering engine to present the two or more translations to the sender for a selection among the two or more translations.

3. The computing device of claim 2, wherein the inference engine is further configured to:
receive the selection among the two or more translations from the sender;
designate the selection among the two or more translations as the translation corresponding to the ideogram; and
save the ideogram and the translation in an ideogram translation dictionary.

4. The computing device of claim 1, wherein the inference engine is further configured to:
detect a structure of the message as the message context, wherein the structure includes one or more words adjacent to the ideogram;
process the one or more words and the ideogram to identify one or more relationships between the one or more words and the ideogram; and
generate the translation of the ideogram based on the one or more relationships with the one or more words.

5. The computing device of claim 4, wherein the inference engine is further configured to:
query an ideogram translation provider with the structure of the message, the one or more words, and the one or more relationships; and
receive the translation from the ideogram translation provider.

6. The computing device of claim 4, wherein the inference engine is further configured to:
query a sentence fragment provider with the structure of the message, the one or more words and the one or more relationships;
receive a sentence fragment that matches the one or more relationships from the sentence fragment provider, wherein the sentence fragment includes the one or more words; and
generate the translation by replacing the one or more words and the ideogram with the sentence fragment within the message.

7. The computing device of claim 1, wherein the inference engine is further configured to:
analyze the sender context to identify an attribute of the sender; and
generate the translation of the ideogram based on a selection of one or more textual equivalents for the ideogram based on the identified attribute.

8. The computing device of claim 1, wherein the inference engine is further configured to:
analyze the recipient context to identify an attribute of the recipient; and
generate the translation of the ideogram based on a selection of one or more textual equivalents for the ideogram based on the identified attribute.

9. The computing device of claim 1, wherein the inference engine is further configured to:
identify two or more textual equivalents for the ideogram;
analyze the two or more textual equivalents based on the one or more of the sender context, the recipient context, and the message context; and
select one of the two or more textual equivalents as the translation based on the analysis.

10. The computing device of claim 1, wherein the inference engine is further configured to:
provide ideogram along with the translation to the communication module to be transmitted to the recipient for display.

11. The computing device of claim 1, wherein the ideogram include one of an icon, a pictogram, and an emoji.

12. A method executed on a computing device to provide ideogram translation, the method comprising:
detecting a message being created, wherein the message includes an ideogram;
determining contextual information associated with the message by analyzing a sender context, a recipient context, or a message context based on one or more of a presence information, an emotional state, or a location of a sender or a recipient;
automatically generating a translation of the ideogram into text by;
generating a list of possible translations based on a content of the ideogram; and
filtering the list of possible translations based on the contextual information associated with the message;
identifying two or more translations of the ideogram;
presenting the two or more translations to the sender for a selection among the two or more translations;
receiving the selection among the two or more translations; and
providing the selection among the two or more translations to a communication module to be transmitted to the recipient for display.

13. The method of claim 12, further comprising:
converting the ideogram to one or more sets of Unicode characters that correspond to the ideogram.

14. The method of claim 13, further comprising:
searching an ideogram translation dictionary using the one or more sets of Unicode characters;
locating one or more words that match the one or more sets of Unicode characters; and
generating translation from the one or more words.

15. The method of claim 12, wherein generating the translation of the ideogram based on the sender context further comprises:
analyzing a history of the sender's messages to other recipients; and
identifying the two or more translations based on the analysis.

16. The method of claim 12, wherein generating the translation of the ideogram based on the recipient context further comprises:
analyzing a history of the recipient's messages from other senders; and
identifying the two or more translations based on the analysis.

17. The method of claim 12, wherein generating the translation of the ideogram based on the message context comprises:
analyzing one or more of a conversation that includes the message, a prior message, and a number of recipients; and
identifying the two or more translations based on the analysis.

18. A computer-readable memory device with instructions stored thereon to provide ideogram translation, the instructions comprising:
receiving a message that includes an ideogram;
determining contextual information associated with the message by analyzing a sender context, a recipient context, or a message context based on one or more of a presence information, an emotional state, or a location of a sender or a recipient;
automatically generating a translation of the ideogram into text by:
generating a list of possible translations based on a content of the ideogram; and
filtering the list of possible translations based on the contextual information associated with the message; and
providing the translation to the recipient of the message for display.

19. The computer-readable memory device of claim 18, wherein the instructions further comprise:
detecting a structure of the message within the message context, wherein the structure includes one or more words adjacent to the ideogram;
processing the one or more words and the ideogram to identify one or more relationships between the one or more words and the ideogram; and
generating the translation of the ideogram based on the one or more relationships with the one or more words.

20. The computer-readable memory device of claim 18, wherein the instructions further comprise:
analyzing one or more of a history of the recipient's messages from other senders, a history of the sender's messages to other recipients, a conversation that includes the message, a prior message, and a number of recipients; and
generating the translation based on the analysis.
